(19) United States
(12) Patent Application Publication
(10) Pub. No.: US 2009/0194567 A1
(43) Pub. Date: Aug. 6, 2009

(54) Press-out device for plastic substances

(75) Inventor: Achim Helmenstein, Engelskirchen (DE)

Correspondence Address: MILES & STOCKBRIDGE PC, 1751 PINNACLE DRIVE, SUITE 500, MCLEAN, VA, 22102-3833, US

(73) Assignee: Fischbach KG Kunststoff-Technik, Engelskirchen (DE)

(21) Appl. No.: 12/320,461

(22) Filed: Jan. 27, 2009

(30) Foreign Application Priority Data
Feb. 2, 2008 (DE) 10 2008 007 306.7

(51) Int. Cl. B67D 3/00; B65D 88/54

(52) U.S. Cl. 222/521; 222/538; 222/327

(57) ABSTRACT

A press-out device for plastic substances comprises a cartridge (10) including a cylindrical container (11) in which a piston (35) can be displaced for pressing a substance, e.g. a sealing substance or adhesive substance, out of a discharge connector (14). The cartridge (10) is provided with an application nozzle (25) for use in extension of the discharge connector (14). The application nozzle (25) belongs to a reclosable closure assembly. The application nozzle (25) further comprises a hood (27) being movable relative to a nozzle body (26) and having a closure orifice. The closure orifice is followed by a discharge channel (51) delimited by straight side walls. The invention makes it possible to open the cartridge (10) without the need for a tool and to adjust and close the application nozzle (25) without the need for a tool.

### BACKGROUND OF THE INVENTION

The present invention relates to a press-out device for plastic substances, comprising
a cartridge comprising a tubular container and a discharge connector extending from an end wall of the container,
a container bottom arranged to be displaced relative to said end wall for pressing out the substance, and
an application nozzle.

Press-out devices of this type serve also as package containers for accommodation of sealing substances, joint sealers, adhesives and the like. The container bottom of such press-out devices is formed as a piston cooperating with the container, said piston being adapted to be advanced by a press-out tool for pressing out the substance from the discharge connector. Within the package container, the substance is hermetically sealed from the environment. To open the package container, a part of the discharge connector will be removed with the aid of a cutting tool, thus clearing an orifice in the discharge connector. Then, the application nozzle will be attached to the discharge connector. By advancing the piston, the substance can be pressed out of the application nozzle and thereby be placed directly onto the application site. e.g. into a joint to be sealed, or into the interior of a corner profile.

A press-out device forming the basis of the precharactering part of claim 1 is described in DE 103 01 029 B4. In this device, the application nozzle is mounted to the discharge connector of the cartridge. The application nozzle together with the discharge connector is operative as a closure means. By rotation of the whole application nozzle, the passage cross-section for the substance discharged from the cartridge can be changed. The closure member of the closure means is integrally formed to the cartridge and thus has an influence on the molding process of the cartridge.

A press-out device wherein the discharge connector is provided with a handle for removal of a tear-off element from the discharge connector, is described in PCT/EP2007/059478 (not prepublished). In this press-out device, the tear-off element can be manually torn off from the discharge connector without a tool being required. Nonetheless, a press-out device of this type is not handled without difficulties because it will be necessary to trim the application nozzle to the currently required size of the nozzle orifice. This is normally performed by cutting off parts of a nozzle body which is formed with a conical channel, thus making it possible to generate nozzle openings of various sizes. For cutting, however, a tool is required also in this prior-art device.

U.S. Pat. No. 4,967,941 A describes a rotatable closure assembly for the cap of a container provided for liquid substances such as mayonnaise, ketchup or similar products. This dosage closure assembly comprises a cap with an opening formed in its end wall. This opening has a stationary peg extending into it. The farther the end wall will be removed from the peg, the larger the cross section of the passage will be. The peg has a cylindrical outer surface, and the opening of the end wall has a cylindrical inner surface.

Described in DE 10 2007 004 763 A1 is a device for application of pasty materials in an automated jointing process. This device comprises an adhesive application nozzle which on its discharge end is formed with a rectangular channel for generating a rectangular adhesive bead. Said channel has the same cross-sectional shape as the adhesive bead which is to be generated, and the adhesive bead is sized to the effect that a specific height of the applied adhesive will be reached and that, in this manner, gaps between carbody components to be mounted to each other can be bridged while allowing large tolerances. No closure means is provided on this nozzle.

It is an object of the present invention to provide a press-out device for flowable substances, such as sealing substances, adhesives and the like, which allows for controlled application without posing special demands to the shape of the cartridge.

### SUMMARY OF THE INVENTION

The press-out device in accordance with the present invention is defined by claim 1. Said press-out device is characterized in that the application nozzle is provided with a hood having a closure opening and being movable relative to the nozzle body, said hood together with the nozzle body forming a closure assembly.

The application nozzle comprises an elongate nozzle body having an axial length at least twice as large as the widest diameter of the nozzle body. Thus, the nozzle has a slim configuration, and the nozzle forms a tool adapted to penetrate into gaps and cavities and to produce a sealing or adhesive seam with high precision, while this process will not be impaired by obstructed vision.

The closure means is an adjustable closure assembly with dosage function and with variable cross section of the passage. This arrangement does not only make it possible to open and close the application nozzle at its discharge end, but also allows for a well-aimed adjustment of the thickness of the substance bead to be pressed out.

In case of a package cartridge, the bottom of the container can be displaced as a piston within a rigid container body. By way of alternative thereto, the container can consist of a flexible film hose to be closed by a container bottom.

The closure assembly can a comprise a stationary peg and a hood arranged for movement relative to the peg. Suitably, the closure orifice is formed with an inner cone, and the peg is formed with an outer cone having a surface shape fitted to that of said inner cone, said inner cone and said outer cone being axially displaceable relative to each other. Between the inner cone and the outer cone, there is thus formed an annular gap whose width can be changed by adjusting the hood. This conical annular gap can be reduced until the sealed state of the closure assembly is reached.

According to a further preferred embodiment, the closure assembly comprises a frustoconical plug held to the nozzle body by means of arms and shaped for fitting surface contact with a closure orifice—formed as an inner cone—of the hood.

A product discharge assembly wherein the product is discharged to the outside directly from the closure orifice is not particularly suited for the forming of product beads from a viscous material. If one were to use a discharge arrangement of this type, the pressed-out substance would be pressed into a spread-out shape and become smudged. According to a preferred embodiment of the invention, it is provided that the closure orifice is followed by a discharge channel. On the one hand, this discharge channel, since it forms a channel-shaped hollow space and, following said hollow space, comprises at least one brushing edge, will facilitate the forming of a substance bead. On the other hand, the discharge channel has the effect that, after the closure means has been closed, a part of the substance will remain in the discharge channel, harden therein and thus additionally close the discharge channel in a sealing manner. For this reason, the discharge channel or the whole application nozzles should be made of a material to which the plastic substance cannot adhere. A typical plastic substance suitable to be pressed out by a press-out device is a silicone material. The application nozzle should consist of a polyolefin, which is a material not susceptible to become tightly adhered to a silicone substance. A plug of the substance which has formed during the press-out process can be pressed out of the discharge channel during the next press-out process.

Preferably, the discharge channel has at least one straight side wall. The discharge channel can have a rectangular shape and comprise side walls of different widths. The end edge of the side wall of the discharge channel forms a trowel or a brushing edge for smoothing the pressed-out substance bead. By the provision of a rectangular channel, it is accomplished that two brushing edges of the above type are made available so that the user can select that side wall which is suited for the respective case.

The possibility exists to fasten the application nozzle to the cartridge in the manner of an accessory, wherein, before use, the application nozzle will be detached and then screwed onto the discharge connector of the cartridge. According to another possible design of the application nozzle, its nozzle body can be integrally formed to the container. In this case, the nozzle body is a fixed component of the container, and it will merely be required to mount the hood onto the nozzle body.

Preferred embodiments of the invention will be explained in greater detail hereunder with reference to the accompanying drawings.

### BRIEF DESCRIPTION OF THE DRAWINGS

FIG. 1 is a perspective view of the cartridge with piston and application nozzle;

FIG. 2 is a perspective view of the nozzle body, with the hood removed.

FIG. 3 is a sectional view of the hood in the closed state, illustrating the nozzle body as positioned within the hood;

FIG. 4 is a view similar to FIG. 3, with the hood in its maximum opening condition;

FIG. 5 is a view of a first embodiment of the hood with rectangular discharge channel;

FIG. 6 is a view of another embodiment of the hood with U-shaped discharge channel;

FIG. 7 is a view of the hood without discharge channel;

FIG. 8 is a view of an alternative embodiment of the closure assembly;

FIG. 9 is a longitudinal sectional view of the closure assembly of FIG. 8 in the opened condition;

FIG. 10 is a longitudinal sectional view of the closure assembly in the closed condition; and

FIG. 11 is a view of a further embodiment.

### DETAILED DESCRIPTION OF PREFERRED EMBODIMENTS

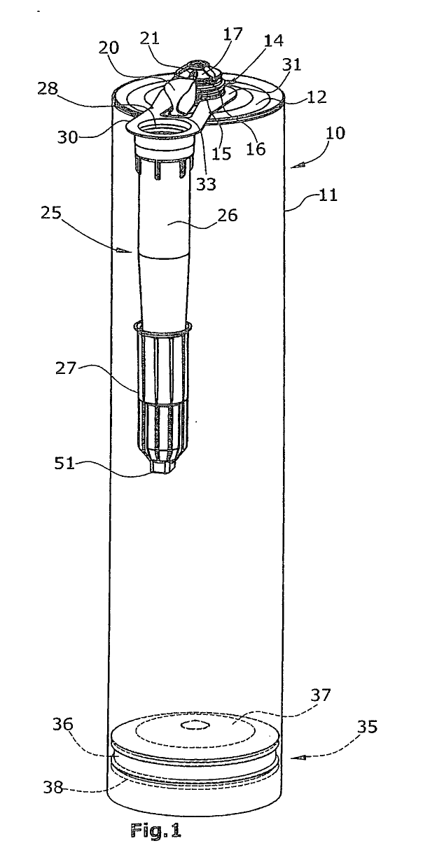

The press-out device for plastic substances illustrated in FIG. 1 comprises a cartridge 10 made of plastic. Cartridge 10 comprises a cylindrical container 11 which on its front end is closed by an end wall 12. The rear end of container 11 is open. Arranged centrally in end wall 12 is a discharge connector 14 extending in the forward direction and provided with a screw thread 15. Discharge connector 14 is provided with an annular predetermined weakening zone 16 and a tear off element 17 formed as a hood. Within said hood, there can be provided a permeation-reducing layer arranged along the inner side of discharge connector 14 and covering the predetermined weakening zone 16 at the inside.

Tear-off element 17 is connected to a handle 20 which is generally of an annular shape and thus can be gripped by insertion of a finger. Said handle can also have different shapes. Handle 20 is connected to tear-off element 17 by an extension 21. The periphery of handle 20 reaches to a position close to end wall 12.

Cartridge 10 is accompanied by an application nozzle 25 to be connected to the cartridge. Application nozzle 25 comprises a substantially tubular nozzle body 26 with a hood 27 screwed to its front end. The rear end of nozzle body 26 is formed with an inner thread 28 for fitting engagement with the screw thread 15 of discharge connector 14. The rear end of nozzle body 26 is further provided with a flap 30 integrally formed thereto. Said flap consists of a flexible wide strip radially extending from the longitudinal axis of application nozzle 25. At a distance from application nozzle 25, flap 30 forms a ring 31 seated in a circumferential groove at the foot of discharge connector 14. Said ring 31 is arranged in locking engagement with groove 32 so that flap 30 can be removed from discharge connector 14 only by application of force.

Flap 30 is formed with a cutout area 33. The latter serves for receiving the lower portion of handle 20. In this manner, flap 30 is fixed against rotation.

After the tear-off element 17 has been torn off with the aid of handle 20, the application nozzle 25 can be pivoted in such a manner, by elastically bending the flap around by about 180°, that the hood 27 will point into the forward direction and thread 28 will be located in front of discharge connector 14. By rotating the application nozzle 25, the screw threads 15 and 28 will be brought into mutual engagement, and the application nozzle 25 will be screwed to cartridge 10. During this process, said ring 31 will rotate in the corresponding groove of discharge connector 14.

Cartridge 10 is further provided with a piston 35. This piston is the press-out piston which is inserted into the rear end of cartridge 10 and can be advanced for pressing out the substance from the opened discharge connector 14. Piston 35 comprises a surrounding piston skirt 36 and an end-side piston face 37. The rear end 38 is open, thus allowing for insertion of the plate of a press-out tool (not shown) for advancing piston 35.

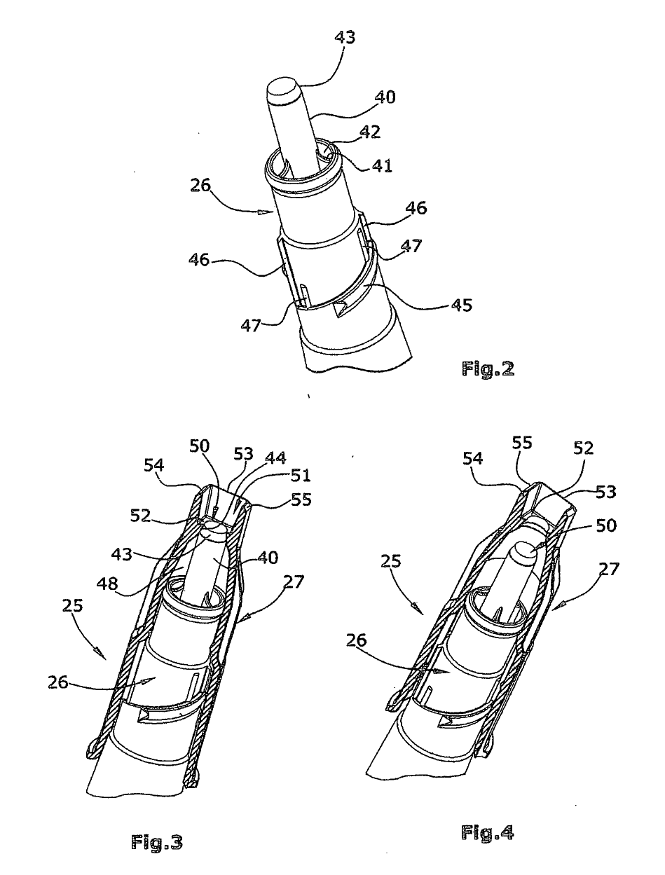

In FIGS. 2-4, nozzle body 26 is illustrated. Nozzle body 26 comprises a tube provided with a peg 40 fastened within the front end of said tube by means of radial webs 41, said peg 40 extending into the tube and projecting beyond the tube end in the forward direction. Between the webs 41, passages 42 are formed, allowing the substance to flow therethrough. At the front end of peg 40, a frustoconical outer cone 32 is provided.

The outer wall of nozzle body 26 comprises a helical threaded web 45, with a corresponding threaded groove of hood 27 seated thereon. Due to the threaded engagement, rotating the hood 27 will also bring about an axial displacement of hood 27 relative to nozzle body 26. For limiting the rotational movement of hood 27, nozzle body 26 is provided with rotation limiting elements 46 formed as longitudinal ribs. Assigned to each rotation limiting element 46 is a locking element 47 adapted to be overcome by hood 27. In this manner, each of the two settings of the hood will be stable.

As shown in FIGS. 3 and 4, the front region of hood 27 includes a hollow space 48 which will be filled with the substance to be pressed out. In the downstream direction, said hollow space is delimited by a closure orifice 44 forming an inner cone. Said inner cone has the same pitch as an outer cone 43 formed on peg 40. In the closed condition according to FIG. 3, outer cone 43 is in full-faced abutment on closure orifice 44. In this situation, the closure assembly 50 formed by hood 27 and nozzle body 26 is in its closed condition. In front of closure assembly 50, a discharge channel 51 of rectangular cross section is arranged. Discharge channel 51 comprises a bottom wall 52 with the closure orifice 44 arranged therein, and straight side walls 53 and 54 forming said rectangular cross section. Side walls 53 and 54 have different edge lengths, thus making it possible to form joint-sealing strands of different widths. The front ends of side walls 53 and 54 present brushing edges 55.

FIG. 3 shows the closed condition and FIG. 4 the fully opened condition of closure assembly 50.

Illustrated in FIGS. 5, 6 and 7 are three different embodiments of hood 27. The hood of FIG. 5 generally corresponds to the hood depicted in FIGS. 3 and 4. This is to say that the discharge channel 51 is enclosed by four side walls 53, 54 and is open only at the front end.

In FIG. 6, discharge channel 51 is enclosed only by three side walls 53, 54, 53 while the fourth side is open. By their respective brushing edges 55, the side walls are operative as smoothing tools for smoothing the strand of substance leaving the discharge channel 51. Hood 27 is made of polyethylene, i.e. a material that will not bind to the silicone material which is the most frequently used plastic substance in the present context. In this manner, formation of an obstructing plug in discharge channel 51 is prevented.

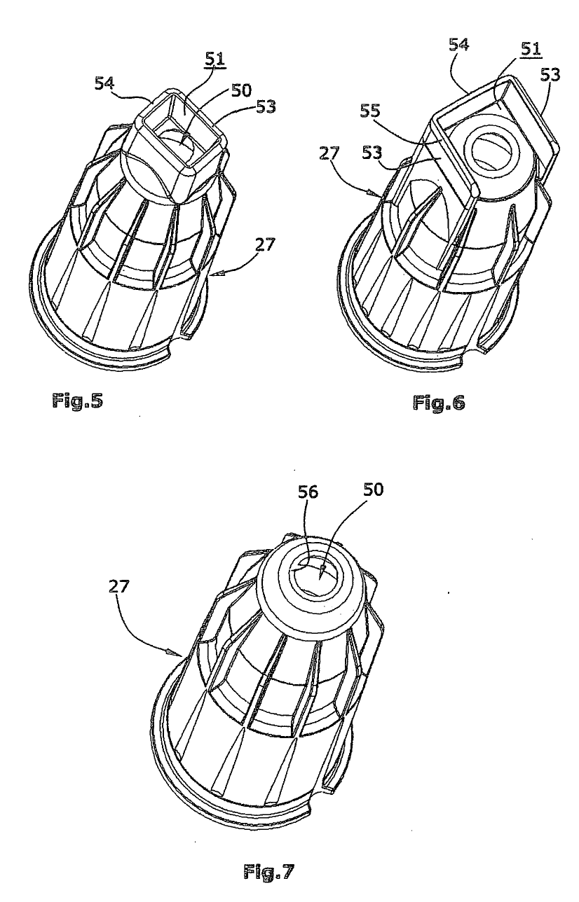

In the embodiment according to FIG. 7, a discharge channel 51 does not exist. The closure assembly 50 forms the front end of the hood. In this embodiment, the discharge orifice 56 is round.

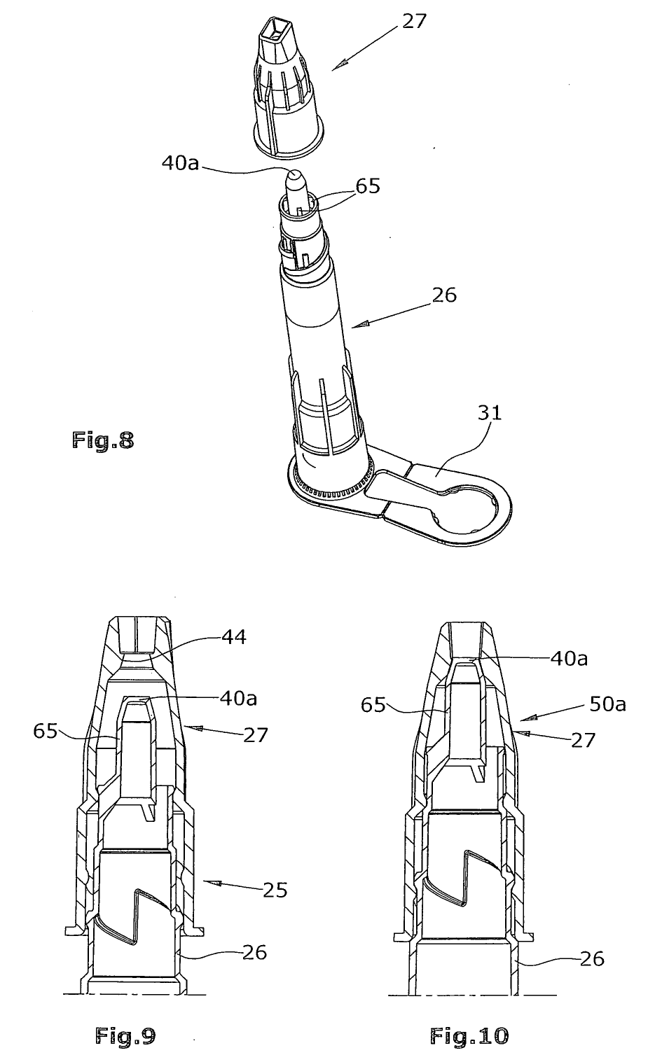

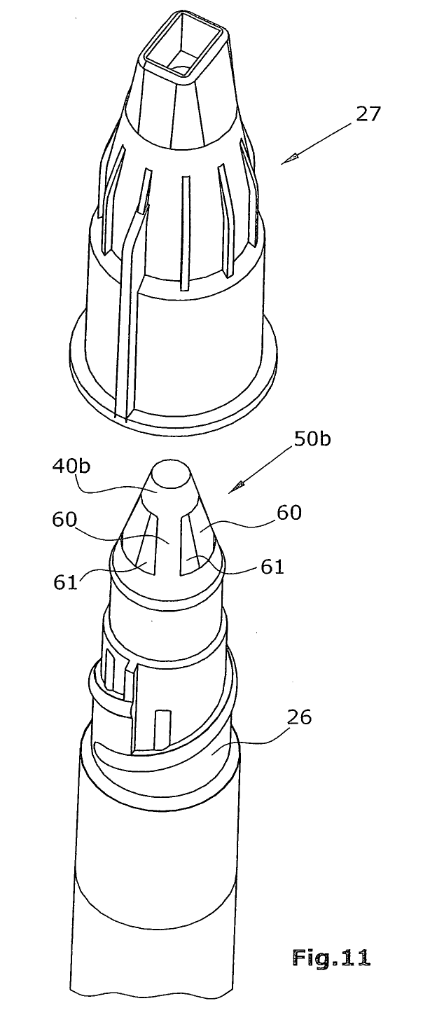

In the embodiments according to FIGS. 8-10, the closure assembly 50a is different from that of the first embodiment. Closure assembly 50a comprises a frustoconical sealing surface 40a forming a part of a hollow peg 65 connected to the tube end of nozzle body 26. Sealing surface 40a cooperates with a closure orifice 44 of hood 27 which is shaped as an inner cone. By rotation of the hood, accompanied by corresponding axial displacement, closure assembly 50a will be opened or closed. Except for these features, nozzle body 26 of hood 27 is configured in the same manner as in the first embodiment.

In the third embodiment shown in FIG. 11, the closure assembly 50b comprises a nozzle body 26 connected to a frustoconical sealing face 40b by arms 60 which have windows 61 arranged between them. Here, in contrast to the previous embodiment, there is provided no hollow peg 65 projecting out of nozzle body 26. Said arms 60 and said windows 61 form a laterally open conical structure joining the peripheral wall of nozzle body 26 in the longitudinal direction thereof. When the closure assembly 50b is being opened, the cone formed by arms 60 and sealing face 40b will be moved away from closure orifice 44 of hood 27, allowing the substance to emerge through the windows 61 of the cone and then to pass through the closure orifice of hood 27.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A press-out device for plastic substances, comprising
a tubular container and a discharge connector extending from an end wall of the container,
a container bottom arranged to be displaced relative to said end wall for pressing out the substance, and
an application nozzle comprising a nozzle body releasably fastened to the discharge connector,
wherein the application nozzle is provided with a moveable hood having a closure orifice and being movable relative to the nozzle body, said hood together with the nozzle body forming a closure assembly.

2. The press-out device according to claim 1 wherein the closure assembly comprises a peg projecting out of a tube of the nozzle body and extending beyond the tube end.

3. The press-out device according to claim 1 wherein the closure assembly comprises a frustoconical sealing surface held by arms and shaped for fitting surface contact with a closure orifice of the hood, said closure orifice being formed as an inner cone.

4. The press-out device according to claim 1 wherein the hood is undetachably fastened to the application nozzle for movement between a closure position and a maximum opening position.

5. The press-out device according to claim 2 wherein the closure orifice comprises an inner cone and the peg comprises an outer cone shaped for fitting surface contact with said inner cone.

6. The press-out device according to claim 1 wherein the hood is in threaded engagement with the nozzle body so that, by rotating the hood, the hood is axially displaced relative to the nozzle body.

7. The press-out device according to claim 6 wherein the nozzle body is provided with rotation limiting elements for the hood.

8. The press-out device according to claim 1 wherein the nozzle body is provided with at least one locking element.

9. The press-out device according to claim 1 wherein the closure orifice is followed by a discharge channel.

10. The press-out device according to claim 9 wherein said discharge channel comprises at least one side wall.

11. The press-out device according to claim 10 wherein said at least one side wall terminates with a brushing edge.

12. The press-out device according to claim 9 wherein said discharge channel is rectangular and has side walls of different widths.

13. The press-out device according to claim 1 wherein the application nozzle is provided with a flap fastened to the discharge connector of the container.

14. The press-out device according to claim 1 wherein the discharge connector comprises a predetermined weakening zone and a tear-off element.

15. The press-out device according to claim 14 wherein said tear-off element is connected to a handle.

16. The press-out device according to claim 1 wherein said tubular container is a cylindrical cartridge and said displaceable container bottom is a piston.
